(19) United States
(12) Patent Application Publication
(10) Pub. No.: US 2006/0068260 A1
(43) Pub. Date: Mar. 30, 2006

(54) Structure of fuel cell

(75) Inventors: Yun-Yu Liu, Taipei City (TW); Yu-Ming Lin, Pingtung County (TW)

Correspondence Address: BACON & THOMAS, PLLC, 625 SLATERS LANE, FOURTH FLOOR, ALEXANDRIA, VA, 22314, US

(73) Assignee: CREATEK PRECISION INTERNATIONAL CO., LTD., Taipei City (TW)

(21) Appl. No.: 10/949,216

(22) Filed: Sep. 27, 2004

(51) Int. Cl. H01M 2/02

(52) U.S. Cl. 429/34

(57) ABSTRACT

A structure of a fuel cell is provided. The fuel cell comprises a housing having a plurality of receiving containers mounted therein; and a plurality of reaction units, wherein one reaction unit is mounted in one receiving container respectively and has one electrode and the other electrode, one of the electrodes and one of the other electrodes are mounted protruding from the housing, and the remaining electrodes and the remaining other electrodes are coupled with one another sequentially such that a state of series connection is formed between the electrodes and the other electrodes.

### BACKGROUND OF THE INVENTION

In general, referring to FIG. 1, a housing 1 is mounted on a conventional fuel cell, wherein the top surface of the housing 1 is one electrode 10 and the bottom surface of the housing 1 is the other electrode 12, and only one reaction unit 14 is mounted inside the housing 1. The reaction unit 14 comprises a metal meshwork 16, an air electrode 17, a leakproof and breathable membrane 18, and a compound 19 mounted sequentially between the electrode 10 and the other electrode 12. In addition, at least a breath hole 13 for enabling exterior air to enter the housing 1 is formed on the surface of the housing 1 so as to generate electric power by reaction between the air electrode 17 and the compound 19.

Besides, each fabricator of the fuel cell makes efforts to develop a fuel cell with higher power capacity. However, no matter what kind of shape and material the fuel cell changes, electric power cannot be generated without reaction between the reaction unit 14 and air. In addition, the reaction unit 14 only generates a constant voltage capacity, a constant voltage, or other constant physical property that limits subsequent applications of the fuel cell. Thus, if it is desired to produce multiple electric power to provide with a proper voltage capacity, a proper voltage, or other proper physical property in a single housing 1, then a plurality of housings 1 must be series-connected or parallel-connected to one another so as to form a higher voltage or a higher power capacity. However, after they are in a state of series connection or parallel connection, the assembled housings will have a very large size and occupy a lot of space. Accordingly, it does not comply with the current development target of minimizing electronic products and limits the application of the fuel cell. Thus, it is an assignment needed to be completed immediately for finding out the way of having various power capacities, various voltages, or various other physical properties in the same space.

### SUMMARY OF THE INVENTION

In view of such circumstances, the inventor has been made sustained researches and experiments to eventually develop a structure of a fuel cell of the present invention and to solve the aforementioned drawbacks of the prior art.

One purpose of the present invention is to provide a structure of a fuel cell, wherein the fuel cell comprises a housing inside which a plurality of reaction units are mounted. Each one of the reaction units can perform the reaction and produce electric power respectively and independently. These reaction units are connected to one another in a state of series connection so as to provide a higher voltage by series connection.

Another purpose of the present invention is to provide reaction units, wherein the reaction units are composed of a plurality of receiving containers mounting in the housing, and a compound, one electrode, and the other electrode which are contained in each receiving container. In addition, one of the electrodes and one of the other electrodes extend outside the housing, and the remaining electrodes and the remaining other electrodes couple with one another sequentially such that the electrodes and the other electrodes are in a state of series connection. Furthermore, at least one breath hole is mounted on the housing for enabling the exterior air to enter the housing through the breath hole and to perform reactions by the reaction units such that the electrodes and the other electrodes are enabled to sequentially transmit electric power produced by these reactions.

In still another purpose of the present invention, a penetration part is mounted on the housing, and one electrode and the other electrode extending outside the housing are mounted on a position corresponding to the penetration part. In addition, the housing includes a series connection portion. When a plurality of housings having an identical structure are stacked with one another, the series connection portion can be applied to connect these housings in series so as to provide with a much higher voltage.

Still another purpose of the present invention is to provide a parallel connection portion. When a plurality of housings having an identical structure are stacked with one another, the parallel connection portion can be applied to connect these housings in parallel so as to provide with a much higher power capacity The above and other objects, features and advantages of the present invention will become apparent from the following detailed description taken with the accompanying drawings.

### BRIEF DESCRIPTION OF THE DRAWINGS

FIG. 1 is a schematic diagram of a conventional fuel cell.

FIG. 2 is a perspective view showing a decomposed diagram of the present invention.

FIG. 3 is a first schematic diagram showing the connection among one electrode, the other electrode and a series connection portion of the present invention.

FIG. 4 is a second schematic diagram showing the connection among the electrode, the other electrode and the series connection portion of the present invention.

FIG. 5 is a first schematic diagram showing the connection among one electrode, the other electrode and a parallel connection portion of the present invention.

FIG. 6 is a second schematic diagram showing the connection among the electrode, the other electrode and the parallel connection portion of the present invention.

FIG. 7 is a schematic diagram showing a cell container of the present invention.

FIG. 8 is schematic diagram showing a first portion and an electrode of the present invention.

FIG. 9 is schematic diagram showing a second portion and the other electrode of the present invention.

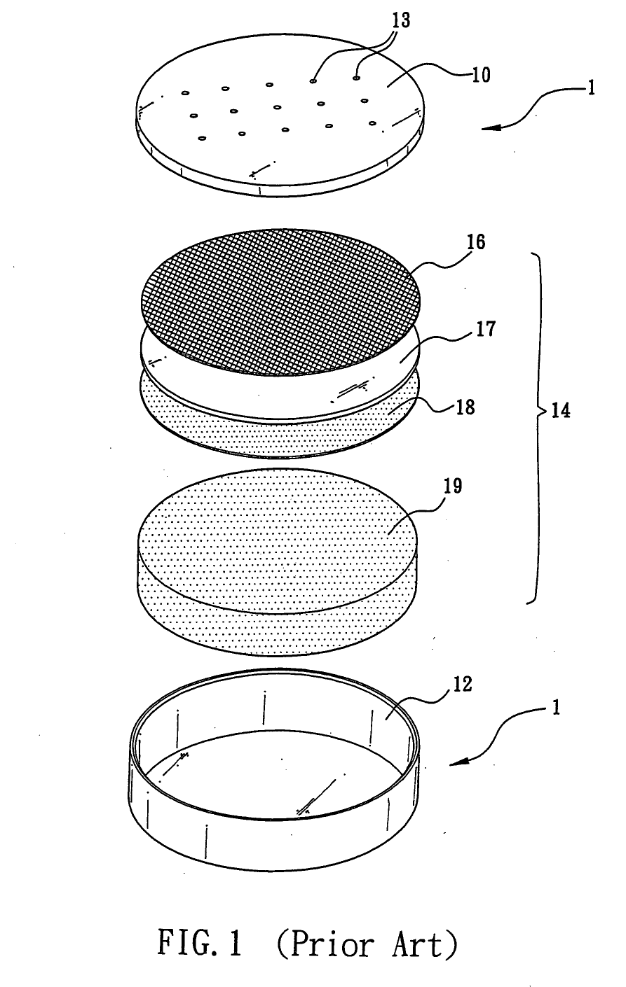

### DETAILED DESCRIPTION OF THE PREFERRED EMBODIMENT

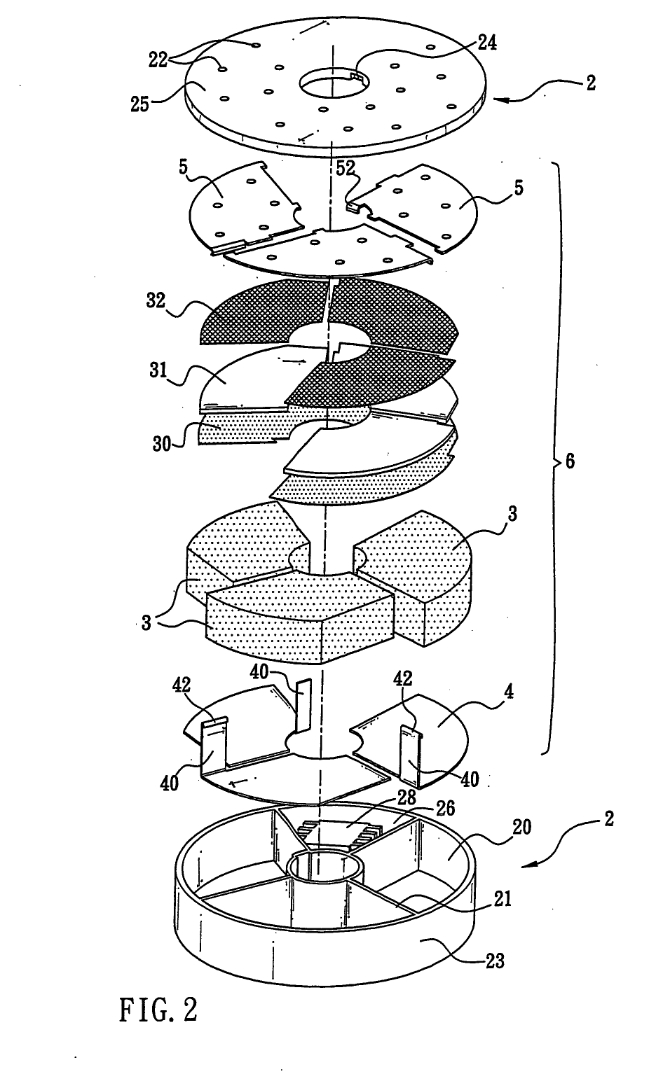

The present invention is a structure of a fuel cell. Referring to FIG. 2, a housing 2 comprising a plurality of receiving containers 20 is provided, wherein a reaction unit 6 comprising one electrode 4 and the other electrode 5 is mounted on every receiving container 20 respectively. Among these reaction units 6, one of the electrodes 4 and one of the other electrodes 5 extend outside the housing 2, and the remaining electrodes 4 and the remaining other electrodes 5 couple with one another such that a series connection is formed between the electrodes 4 and the other electrodes 5. Accordingly, after the reaction units 6 generate electric power, the electrodes 4 and the other electrode 5 transmit electric power produced from reactions in sequence. Owing to the series connection, the electrode 4 and the other electrode 5 extending outside the housing 2 can provide a higher voltage.

In the reaction unit 6 of the present invention, a compound 3, a leakproof and breathable membrane 30, an air electrode 3 1, and a metal meshwork 32 are mounted between the electrode 4 and the other electrode 5. In addition, at least a breath hole 22 is mounted on the other electrode 5 and a surface of the housing 2 facing the other electrode 5 such that electric power is generated by a reaction between the air electrode 31 and the compound 3 after air enters the fuel cell through the breath hole 22. The electrodes 4 and the other electrodes 5 will transmit electric power produced from the reactions in sequence. Because of the series connection, the electrode 4 and the other electrode 5 mounting outside the housing 2 can provide a higher voltage.

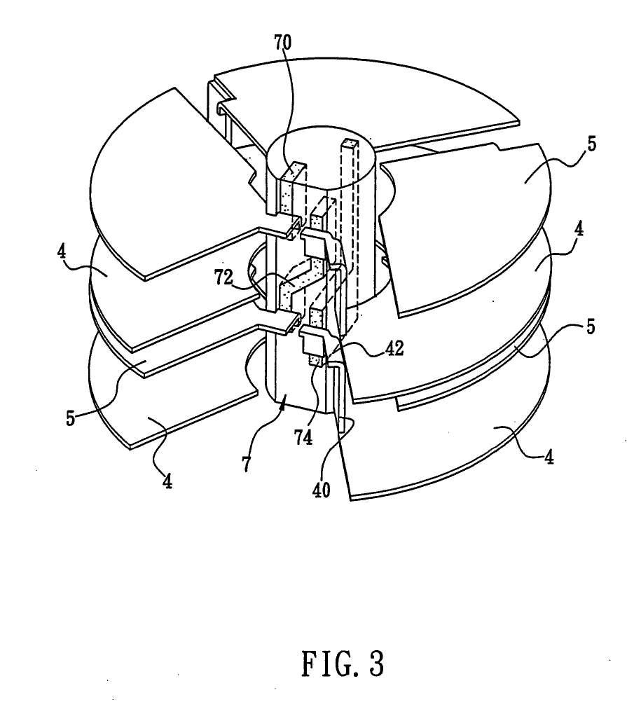

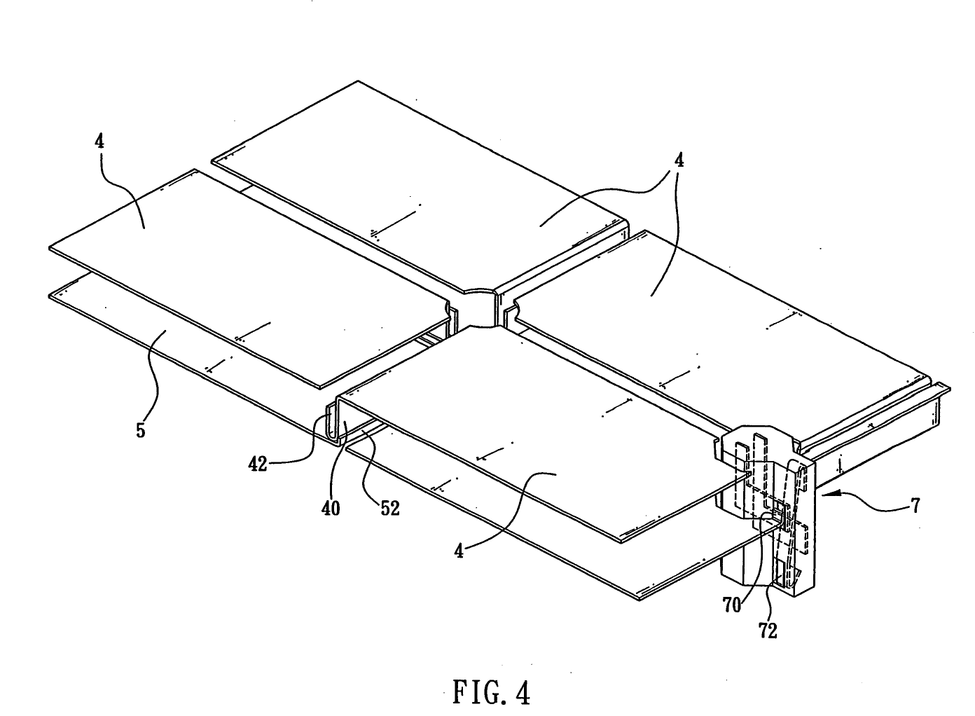

In one preferred embodiment of the present invention, the housing 2 includes a penetration part 24 on which the electrode 4 and the other electrode 5 mounting outside the housing 2 are mounted. In addition, the housing 2 includes a series connection portion 7 (as shown in FIG. 3 and FIG. 4). A first series connection part 70, a second series connection part 72, and a third series connection part 74 are mounted protruding from the surface of the series connection portion 7. Therefore, when a plurality of housings 2 with identical structure are stacked with one another, the series connection portion 7 can pass through the penetration part 24 such that the first series connection part 70 is connected to the other electrode 5 extending outside the topmost housing 2. The third series connection part 74 is connected to the electrode 4 extending outside the bottommost housing 2. The second series connection part 72 is connected to the remaining electrodes 4 and the remaining other electrodes 5 extending outside the housing 2 such that these housings 2 are connected to one another by the series connection portion 7 so as to provide with a higher voltage for complying with the required voltage of high voltage electronic products.

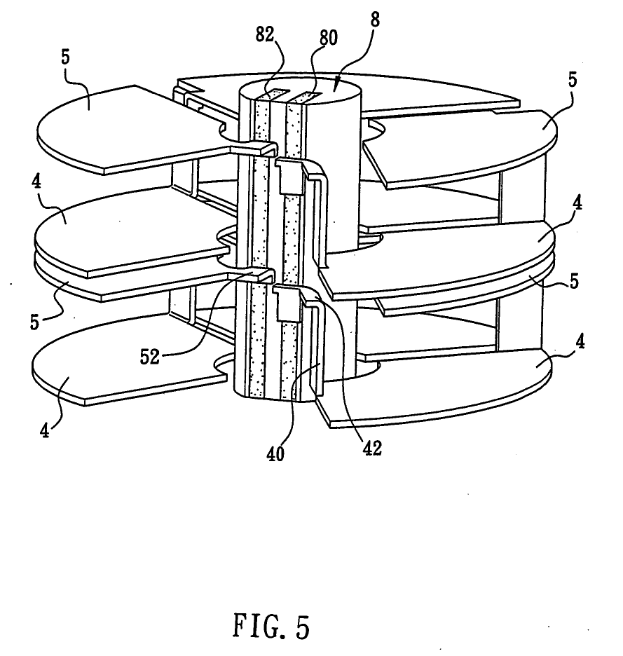

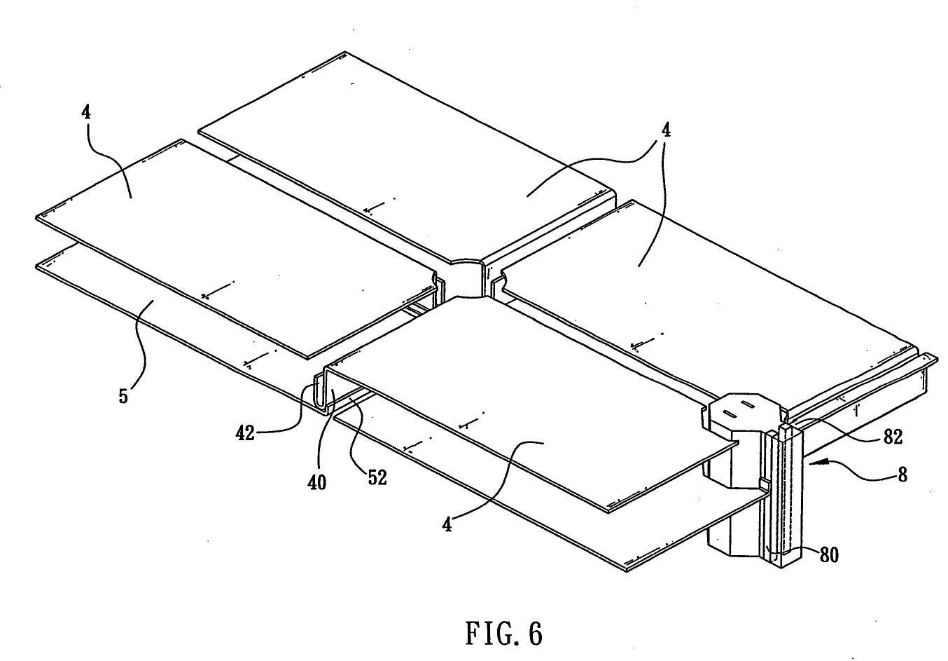

In another preferred embodiment of the present invention, a parallel connection portion 8 (as shown in FIG. 5 and FIG. 6) is provided. The parallel connection portion 8 includes one parallel connection part 80 and the other parallel connection part 82 extending outside the surface of the parallel connection portion 8. When a plurality of housings 2 with identical structure are stacked with one another, the parallel connection portion 8 can pass through the penetration part 24 such that the parallel connection part 80 is able to connect to each electrode 4 extending outside the housing 2 and the parallel connection part 82 is able to connect to each electrode 5 extending from the housing 2. Therefore, these housings 2 are connected to one another through the parallel connection portion 8 so as to provide with more higher power capacity.

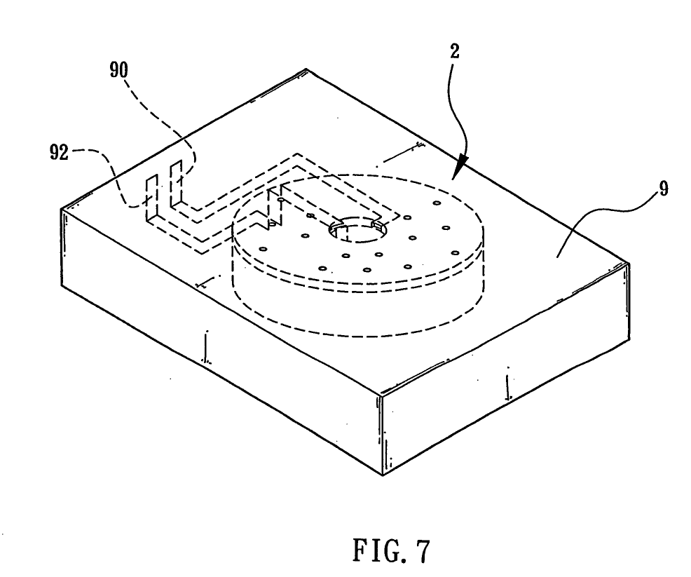

In these preferred embodiments, as shown in FIG. 7, a cell container 9 is further provided. The outward appearance of the cell container 9 is in the form of a button cell, a mercury cell, a common portable electronic product, for example, a mobile phone, a Personal Digital Assistant (PDA), a notebook, or the like. The cell container 9 includes one electro-contact part 90 and the other electro-contact part 92, wherein the electro-contact part 90 is connected to the electrode 4 extending outside the housing 2, the first series connection part 70 of the series connection portion 7, or a parallel connection part 80 of the parallel connection portion 8, and the electro-contact part 92 is connected to the other electrode 5 extending outside the housing 2, the third series connection part 74 of the series connection portion 7, or the other parallel connection part 82 of the parallel connection portion 8. Accordingly, after the reaction unit 6 mounted in the housing 2 performs a reaction, the electro-contact part 90 and the electro-contact part 92 can supply with electric power that is produced from the reaction of the individual reaction unit 6.

In order to manipulate the moving status of electric product, which is connected to the housing, and the method of supplying electric power, the housing 2, in these preferred embodiments, further includes a control container 26 within which a control circuit 28 is mounted for manipulating the supplying method of the electric power or the movement of the electric product by connecting the control circuit 28 to the electric product.

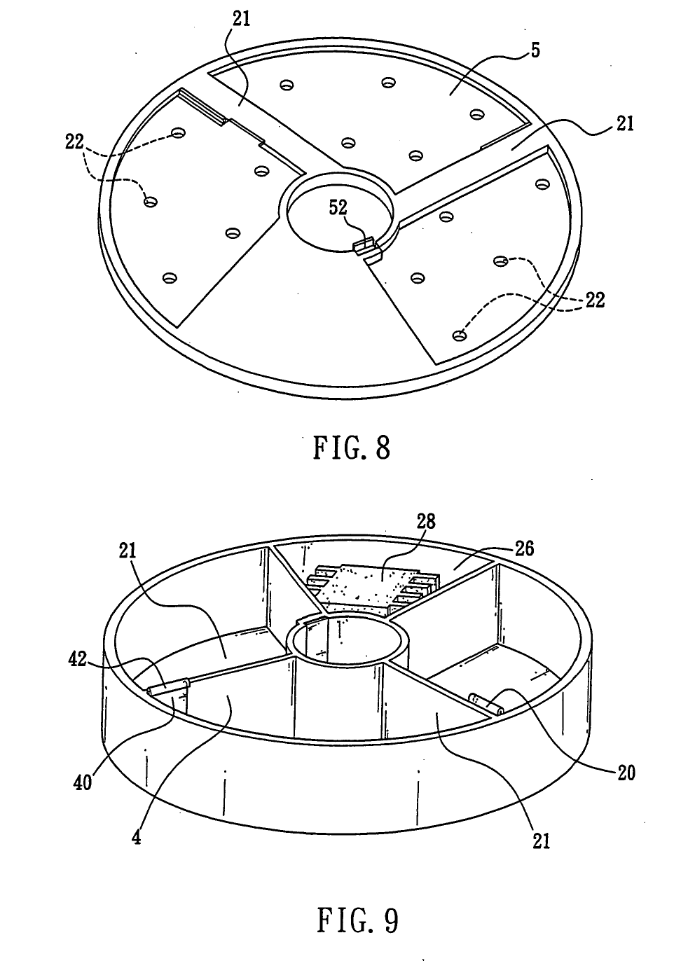

In these preferred embodiments, the housing 2 includes a plurality of partition plates 21 mounting therein. Two random partition plates 21 form these receiving containers 20 and the control container 26. In addition, the housing 2 is composed of a first portion 23 and a second portion 25 (as shown in FIG. 8 and FIG. 9), wherein one end of the partition plate 21 is connected to the first portion 23, and the other end of the partition plate 21 is connected to the second portion 25. In other words, two random partition plates 21 locating between the first portion 23 and the second portion 25 form these receiving containers 20 and the control container 26. Moreover, in the receiving containers 20, each of these electrodes 4 includes one extension part 40 extending toward and near the second portion 25. However, in the receiving containers 20, one of the other electrodes 5 includes the other extension part 52 extending toward the first portion 23. One extension part 40 and one extension part 52 extend outside the housing 2, and the remaining extension parts 40 include a contact part 42 mounting thereon. These contact parts 42 are sequentially coupled with the other electrodes 5 adjacent to thereof such that each electrode 4 and each electrode 5 mounting in the housing 2 are connected to one another in series.

According to the above mechanisms, electric power is generated respectively from the reactions of these reaction units 6 mounted in the housing 2 which is connected to one another in series even though the partition plates 21 cause the produced power capacity slightly small than that of the conventional fuel cell. In other words, if the fuel cell of the present invention has the same size as that of the conventional fuel cell, the present invention can provide a higher voltage, which is never provided by the conventional fuel cell. Moreover, if the parallel connection portion 8 is connected with plural fuel cells, these fuel cells can provide with a higher power capacity so as to cure the deficiency of having a smaller power capacity in the prior art. Furthermore, for the same power capacity and voltage, the overall thickness of the present invention having the plural housings 2 connected to one another by the parallel connection portion 8 is smaller than that of the conventional fuel cells, which are connected to one another in series.

While the invention herein disclosed has been described by means of specific embodiments, numerous modifications and variations could be made thereto by those skilled in the art without departing from the scope and spirit of the invention set forth in the claims.

What the invention claimed is:

1. A structure of a fuel cell comprising:
a housing having a plurality of receiving containers mounted therein; and
a plurality of reaction units, wherein one reaction unit is mounted in one receiving container respectively and has one electrode and the other electrode, one of the electrodes and one of the other electrodes are mounted protruding from the housing, and the remaining electrodes and the remaining other electrodes are coupled with one another sequentially such that a state of series connection is formed between the electrodes and the other electrodes.

2. The structure of claim 1, wherein each reaction unit further comprises:
a compound mounted in the receiving container;
a leakproof and breathable membrane mounted on a surface of the compound opposing the electrode in the receiving container for preventing the compound from leakage and enabling air to enter the compound;
an air electrode mounted on a surface of the leakproof and breathable membrane opposing the compound in the receiving container;
a metal meshwork mounted on a surface of the air electrode opposing the leakproof and breathable membrane in the receiving container; and
a plurality of breath holes mounted on the other electrode and a surface of the housing facing the other electrode, wherein electric power is produced by a reaction between the air electrode and the compound after air passes through the breath holes, and the electrodes and the other electrodes will transmit the electric power produced by the reaction in sequence.

3. The structure of claim 1, wherein the housing includes a penetration part on which the electrode and the other electrode extending outside the housing is mounted;
the housing also includes a series connection portion on which a first series connection part, a second series connection part, and a third series connection part are mounted protruding from a surface of the series connection portion;
therefore when a plurality of housings with identical structure are stacked with one another, the series connection portion can pass through the penetration parts such that the first series connection part is connected to the electrode extending outside a topmost housing, the third series connection part is connected to the electrode extending outside a bottommost housing, and the second series connection part is connected to the remaining electrodes and the remaining other electrodes extending outside the housing so as to connect the housings with one another through the series connection portion.

4. The structure of claim 1, wherein the housing includes a penetration part on which the electrode and the other electrode extending outside the housing is mounted;
the housing also includes a parallel connection portion on which one parallel connection part and the other parallel connection part are mounted protruding from a surface of the parallel connection portion;
therefore when a plurality of housings with identical structure are stacked with one another, the parallel connection portion can pass through the penetration parts such that the parallel connection part is connected to each electrode extending outside the housing, the other parallel connection part is connected to the other electrode extending outside the housing so as to connect the housings with one another through the parallel connection portion.

5. The structure of claim 1, wherein further comprises a cell container having one electro-contact part and the other electro-contact part mounted thereon, wherein the electro-contact part is connected to the electrode extending outside the housing, and the electro-contact part is connected to the other electrode extending outside the housing.

6. The structure of claim 3, wherein further comprises a cell container having one electro-contact part and the other electro-contact part mounted thereon, wherein the electro-contact part is connected to the first series connection part of the series connection portion, and the other electro-contact part is connected to the third series connection part of the series connection portion.

7. The structure of claim 4, wherein further comprises a cell container having one electro-contact part and the other electro-contact part mounted thereon, wherein the electro-contact part is connected to the parallel connection part of the parallel connection portion, and the other electro-contact part is connected to the other parallel connection part of the parallel connection portion.

8. The structure of claim 1, wherein the housing further comprises a control container within which a control circuit is mounted therein for manipulating a power supplying method of the fuel cell.

9. The structure of claim 1, wherein the housing further comprises a control container within which a control circuit is mounted therein for manipulating the movement of an electric product by connecting the control circuit to the electric product.

10. The structure of claim 2, wherein the housing includes a plurality of partition plates mounted therein, and two random partition plates form the receiving containers.

11. The structure of claim 10, wherein the housing is composed of a first portion and a second portion, wherein one end of the partition plates is connected to the first portion, and the other end of the partition plates is connected to the second portion, namely, two random partition plates form the receiving containers.

12. The structure of claim 11, wherein the electrodes include one extension part extending toward and near the second portion in the receiving containers respectively;
one of the other electrodes mounted in the receiving containers includes the other extension part extending toward the first portion; and
one of the extension parts and one of the other extension parts extend outside the housing, the remaining extension parts include a contact part mounting thereon, and the contact parts are sequentially coupled with the other extension parts adjacent to thereof such that the electrode and the other electrode mounted in the housing are connected to one another in series.
